(19) United States
(12) Patent Application Publication
(10) Pub. No.: US 2025/0103912 A1
(43) Pub. Date: Mar. 27, 2025

(54) GENERATING FACT TREES FOR DATA STORYTELLING

(71) Applicant: Adobe Inc., San Jose, CA (US)

(72) Inventors: Raunak SHAH, Bangalore (IN); Vibhor PORWAL, Auraiya (IN); Koyel MUKHERJEE, Bangalore (IN); Iftikhar Ahamath BURHANUDDIN, Bangalore (IN); Saurabh MAHAPATRA, Sunnyvale, CA (US); Annamalai ANNAMALAI, San Jose, CA (US); Fan DU, Milpitas, CA (US)

(21) Appl. No.: 18/471,996

(22) Filed: Sep. 21, 2023

(51) Int. Cl. G06N 5/022

(52) U.S. Cl. CPC G06N 5/022

(57) ABSTRACT

A data insight generation system generates facts from a dataset. Importance scores are determined for the facts. Facts having the highest importance scores are generated for display at a user interface. A selection of a displayed fact is received. Based on the selection, dependent facts are generated by adding subspaces to the selected fact. The dependent facts are generated for display at the user interface.

### BACKGROUND

Many datasets are structured in a tabular format. Often—especially in the enterprise context—these datasets can be petabytes in size. The datasets' large sizes make it difficult to summarize or glean meaningful insights into the datasets.

### SUMMARY

Some aspects of the present technology relate to, among other things, a data insight generation system that allows for intuitively exploring a visual fact tree regarding a dataset. An initial set of relatively high-level facts is generated automatically by sampling the dataset. The initial facts are scored based on entropy, and the highest-scoring initial facts are selected for display. Based on a selection of a displayed fact, dependent facts branching from the selected fact are generated for display. In some aspects, the dependent facts are determined for a selected fact by adding subspaces (e.g., conditions) to the selected fact and scoring the dependent facts based on their respective entropies. In this manner, the data insight generation system provides for intuitively investigating facts about the dataset at different levels of granularity—in some cases, without requiring a user query.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is an exemplary process of generating and presenting facts in accordance with some implementations of the present disclosure;

FIG. 3 is an exemplary visual representation of a fact in accordance with some implementations of the present disclosure;

FIG. 4 is an exemplary fact tree in accordance with some implementations of the present disclosure;

FIG. 5 is an exemplary visual representation of a dependent fact in accordance with some implementations of the present disclosure;

FIGS. 6A-6B illustrate an exemplary process for generating and selecting fact trees in accordance with some implementations of the present disclosure;

FIGS. 7-9 are flow diagrams showing methods of providing data insights in accordance with some implementations of the present disclosure; and

FIG. 10 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “fact” refers to information found within a dataset. A fact comprises parameters (or object values) that can be conveyed using a data visualization. For example, a fact can comprise a tuple comprising a type, a subspace, a measure, a breakdown, and an aggregate. In this example, type, subspace, etc. comprise parameters that are associated with values.

As used herein, the term “dependent fact” refers to a fact that contains a subset of information found in another fact—i.e., a “parent fact.” For example, a dependent fact can comprise a same tuple as its parent fact except for the inclusion of an additional subspace (e.g., condition).

As used herein, the term “fact tree” refers to a set of connected facts. In some aspects, a fact tree is comprised of nodes—each node representing a fact—and directed edges connecting related nodes to one another.

As used herein, the term “dataset” refers to a collection of sets of information. In some aspects, a dataset comprises information organized in a tabular format.

As used herein, the term “importance score” refers to a value reflecting the importance of a fact.

As used herein, the term “entropy score” refers to a value reflecting the amount of information in a fact.

As used herein, the term “subspace” refers to a condition or filter that specifies a subset of a dataset.

### Overview

Many approaches have been undertaken in attempt to glean useful information from large datasets. Some conventional approaches require a user to query the dataset; these approaches may create visualizations of the resulting data. But often, the dataset is so large and/or complex that the user does not know where to begin (i.e., does not know how to query the data to obtain interesting information).

In addition to being difficult to use, these approaches can incur undue computational costs associated with receiving, parsing, and executing queries. For instance, repetitive queries result in packet generation costs that adversely affect computer network communications. Each time a user issues a query, the contents or payload of the search query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on a non-volatile disk) because each time a user inputs information, such as queries, the computing system has to reach out to the storage device to perform a read or write operation, which is time consuming, error prone, and can eventually wear on components, such as a read/write head. Further, if users repetitively issue queries, it is expensive because processing search queries consumes a lot of computing resources. For example, for some search engines, a query execution plan is calculated each time a search query is issued, which requires a search system to find the least expensive query execution plan to fully execute the search query. This decreases throughput and increases network latency and can waste valuable time.

Other approaches automatically create data insights (e.g., visualizations) without user input. But these insights often have low information value and/or limited user interactivity. Thus, these approaches still require the user to repeatedly query the dataset to find the desired information, implicating the read/write and network costs discussed above.

Aspects of the technology described herein improve computers' ability to provide useful insights on datasets. At a high level, initial, summary-level facts are determined from a dataset and generated for presentation. In some aspects, the initial, summary-level facts are determined from the dataset automatically without any user input (e.g., query inputs, specified parameters, etc.). Due at least in part to their higher-level nature, these initial facts are relatively computationally inexpensive to generate. In response to selection of an initial fact of interest, dependent facts related to the selected fact are identified from the dataset and generated for presentation. In this manner, the system facilitates investigation of interesting aspects of a dataset in a computationally efficient manner and without the need to repeatedly query the dataset.

The initial, summary-level facts can be generated by sampling various combinations of parameters (which are explained in more detail below). The facts can be distributions of data from the dataset—e.g., “Percentage of Global Market Share by Car Brand.” In order to determine which of these facts are the best candidates for presentation to a user, an importance score is determined for each fact. The importance score can be based on an entropy of the fact. This approach prefers facts associated with uneven (i.e., non-uniform) data distributions, which are more likely to be of interest than high-entropy (uniform/homogeneous) facts or low-entropy facts (which may only comprise one category). The initial facts with the highest importance scores are selected and presented to the user.

Because the initial facts explain the dataset at a relatively high level of generality (in some aspects), the user may wish to explore the facts at a more granular level. Aspects herein allow the user to select a fact; based on the selection, dependent facts are displayed (e.g., branching from the selected initial fact). The dependent facts are generated by adding one or more subspaces (e.g., conditions) to the selected fact and are subject to a similar entropy-scoring process as the initial facts to determine which should be presented to the user. In this way, dependent facts (and facts that depend from the dependent facts, and so on) can be iteratively generated and displayed such that the user can examine interesting aspects of the dataset in the desired manner.

Aspects of the technology described herein provide computationally efficient methods of extracting useful, representative information from datasets—e.g., without analyzing or parsing the entire dataset. Aspects herein also reduce or eliminate the computational costs associated with receiving, parsing, and executing user queries, which are discussed above. Moreover, the iterative approach to providing data insights describes herein—e.g., by beginning with summary-level facts and focusing on progressively narrower portions of the dataset as each dependent fact is selected-obviates the need to run computationally expensive operations on much or all of the dataset.

### Example Data Insight Generator

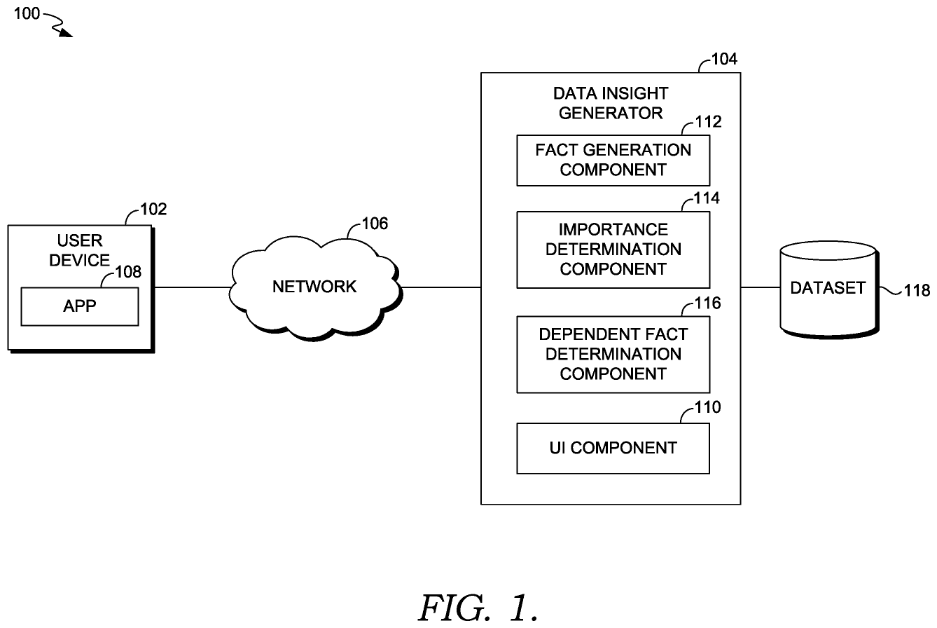

With reference now to the drawings, FIG. 1 is a block diagram illustrating an exemplary system 100 for generating data insights in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

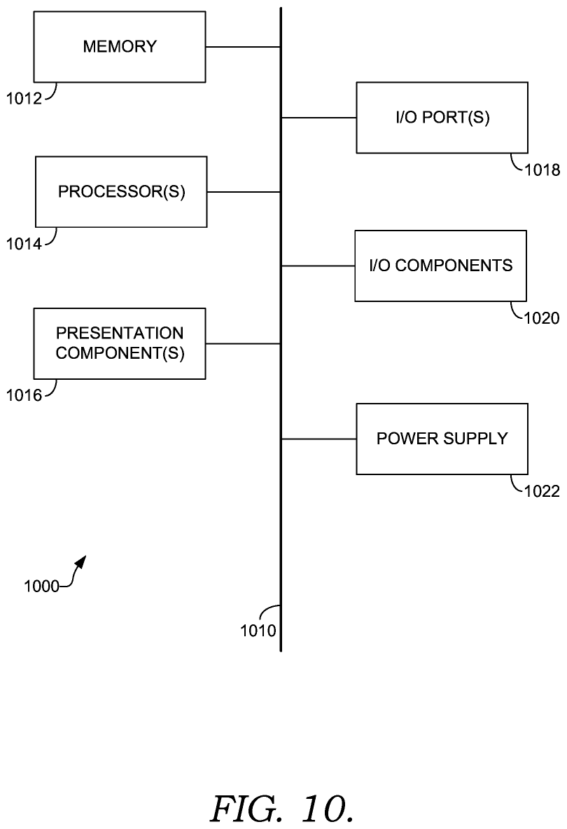

The system 100 is an example of a suitable architecture for implementing certain aspects of the present disclosure. Among other components not shown, the system 100 includes a user device 102, a data insight generator 104, and a dataset 118. Each of the user device 102 and data insight generator 104 shown in FIG. 1 can comprise one or more computer devices, such as the computing device 1000 of FIG. 10, discussed below. As shown in FIG. 1, the user device 102 and the data insight generator 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of client devices and server devices can be employed within the system 100 within the scope of the present technology. Each can comprise a single device or multiple devices cooperating in a distributed environment. For instance, the data insight generator 104 can be provided by multiple server devices collectively providing the functionality of the data insight generator 104 as described herein. Additionally, other components not shown can also be included within the network environment.

The user device 102 can be a client device on the client side of operating environment 100, while the data insight generator 104 can be on the server side of operating environment 100. The data insight generator 104 can comprise server-side software designed to work in conjunction with client-side software on the user device 102 so as to implement any combination of the features and functionalities discussed in the present disclosure. For instance, the user device 102 can include an application 108 for interacting with the data insight generator 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the data insight generator 104 remain as separate entities. While the operating environment 100 illustrates a configuration in a networked environment with a separate user device and data insight generator, it should be understood that other configurations can be employed in which components are combined. For instance, in some configurations, a user device can also provide capabilities of the technology described in association with the data insight generator 104.

The user device 102 can comprise any type of computing device capable of use by a user or designer. For example, in one aspect, the user device can be the type of computing device 1000 described in relation to FIG. 10 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the data insight generator 104 via the user device 102.

At a high level, the data insight generator 104 generates facts from the dataset 118. Importance scores are generated for the facts. In some aspects, the importance scores are based at least in part on normalized entropy scores for the facts. Facts with the highest importance scores are generated by the user interface component 110 for display on the user device 102, for instance, via the application 108. A selection of a displayed fact is received, and dependent facts for the selected fact are generated and generated by the user interface component 110 for display on the user device 102, for instance, via the application 108.

As shown in FIG. 1, the data insight generator 104 includes a fact generation component 112, an importance determination component 114, and a dependent fact determination component 116. The components of the data insight generator 104 can be in addition to other components that provide further additional functions beyond the features described herein. The data insight generator 104 can be implemented using one or more server devices, one or more platforms with corresponding application programming interfaces, cloud infrastructure, and the like. While the data insight generator 104 is shown separate from the user device 102 in the configuration of FIG. 1, it should be understood that in other configurations, some or all of the functions of the data insight generator 104 can be provided on the user device 102.

In one aspect, the functions performed by components of the data insight generator 104 are associated with one or more applications, services, or routines. In particular, such applications, services, or routines can operate on one or more user devices or servers, be distributed across one or more user devices and servers, or be implemented in the cloud. Moreover, in some aspects, these components of the data insight generator 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, although functionality is described herein with regards to specific components shown in example system 100, it is contemplated that in some aspects, functionality of these components can be shared or distributed across other components.

The fact generation component 112 is configured to generate facts from the dataset 118. The fact generation component 112 can initiate the fact generation process in response to receiving a dataset (e.g., via user upload), a user logon event (e.g., a user logging on to or accessing the application 108), or a user viewing or accessing a dashboard where a data visualization is to be displayed (e.g., in the application 108), for example.

As discussed above, as used herein, the term “fact” refers to information found within a dataset, such as the dataset 118. A fact comprises parameters (or objects) that can be conveyed using a data visualization. In some aspects, a fact is a tuple comprising a type, a subspace, a measure, a breakdown, and an aggregate. A “type” can be a type of visualization to be created (e.g., a trend line, bar graph, pie chart, or ranking). A “subspace” can be a condition or filter that specifies a subset of the dataset 118 (e.g., city=New York). A “measure” can be a manner in which data is quantified. A “breakdown” can be a discretized column—that is, a categorical column or a numerical column that is discretized—of interest. An “aggregate” can be a quantitative determination based on the subspace, measure, and breakdown (e.g., a total or median).

To illustrate, if the dataset 118 contains data regarding a company's car sales, the fact generation component 112 can generate the fact “The top three car profits are [$5M, $3M, $1M] when the models are [Model A, Model B, Model C] and city=New York.” This fact can be represented as the tuple {type=RANK, subspace=New York, measure=Car Profit, breakdown=Model, aggregate=Sum}.

The dataset 118 from which the fact generation component 112 generates facts can comprise tabular data. The tabular data comprises rows, columns, and cells at the intersections of the rows and columns. Facts generated by the fact generation component 112 can correspond to respective columns of the tabular data (e.g., based on the “breakdown” parameter, as previously discussed).

In order to generate an initial set of facts from the dataset 118, the fact generation component 112 can sample a plurality of combinations of types, subspaces, measures, breakdowns, and/or aggregates from the dataset 118. In some aspects, the fact generation component 112 samples combinations of types, subspaces, and breakdowns—but not measures or aggregates, which, in some aspects, are constants that are determined by the “type,” “subspace,” and “breakdown” parameters. In still other aspects, the fact generation component 112 samples combinations of types and breakdowns—but not subspaces, measures, or aggregates. In these aspects, subspaces can be subsequently added to the initial facts by the dependent fact determination component 116, as discussed below.

To illustrate, for a given fact, if type=Pie Chart, subspace=Model A, and breakdown=Cities, measure=Count, aggregate=Sum, the fact's visualization will be a pie chart showing a number of Model A cars for each city. Here, “count” is a column in the dataset, and “measure” could be any other numerical column of the dataset (e.g., “Revenue”). Thus, in aspects, the fact generation component 112 need not vary the “measure” and “aggregate” parameters.

In order to avoid creating facts having low information value, in some aspects, the fact generation component 112 filters out columns and/or rows of the tabular data. That is, the fact generation component 112 can exclude a column or row from selection as a subspace during the sampling process, for example.

In some aspects, the fact generation component 112 filters out columns and/or rows based on a number or proportion of unique values in the column/row. For example, if the number or proportion of unique values in the column/row is below a threshold, the column/row may be filtered out. To illustrate, if the dataset 118 only contains data regarding a particular car model, every value in a “Model” column could be the same. Accordingly, the fact generation component 112 could filter out the “Model” column—e.g., such that facts having the breakdown “Model” are not created.

In some aspects, the fact generation component 112 filters out columns and/or rows based on a number or proportion of null values (e.g., empty cells) in the column/row. For example, if the number or proportion of null values in the column/row is above a threshold, the column/row may be filtered out. To illustrate, suppose that (a) the dataset 118 contains customer account data and (b) the “phone number” field was optional (i.e., not required to be filled out by the customer) during account setup. In this case, many cells in a “Phone Number” column of the data could be empty (null). Accordingly, the fact generation component 112 could filter out the “Phone Number” column—e.g., such that facts having the breakdown “Phone Number” are not created.

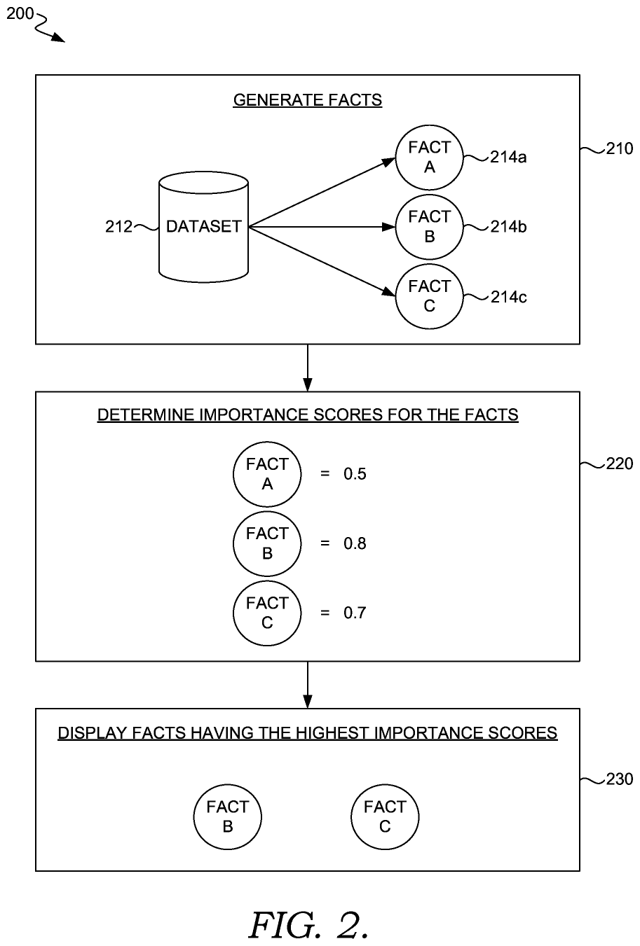

The fact generation component 112 can terminate the fact generation process once a predetermined number of facts has been generated, for example. As shown at block 210 of FIG. 2 (which generally illustrates an exemplary process 200 for generating and displaying facts), for example, the fact generation component 112 generates three facts 214a, 214b, and 214c from the dataset 212 (which can correspond to the dataset 118 of FIG. 1). However, this is merely an example for purposes of illustration, and it is contemplated that in most aspects, the fact generation component 112 will generate more than three facts.

The importance determination component 114 determines importance scores for the facts generated by the fact generation component 112 (as shown at block 220 of FIG. 2). One importance score can be generated for each fact.

Each importance score can be at least partially based on an entropy score for the respective fact. At a high level, an entropy score for a fact measures the amount of entropy present in the numerical distribution associated with the fact. A fact's normalized entropy score can, for example, be calculated according to the following formula:

$$H ( X ) = ( 1 / N ) ( - {\sum }_{i = 1}^{N} p ( {x}_{i} ) {log}_{2} p ( {x}_{i} ) ) ,$$

where X is the data distribution {x₁, x₂, . . . , x_{N}} for the fact for which entropy is to be determined, p(xᵢ) is the probability of occurrence of the ith value in X, and N is the total number of unique values in X.

In this manner, the importance determination component 114 can calculate the information value of a fact. That is, facts having lower entropy scores are less likely to present useful data insights, while facts having higher entropy scores are more likely to present useful data insights. For example, a fact for which every value is the same would be of high information value and would have an entropy score of log N; a fact having a larger number of unique values would have a higher entropy score (and therefore a higher importance score). A fact having fewer unique values would have a lower entropy score (and therefore a lower importance score).

The importance determination component 114 further selects a plurality of facts having the highest importance scores (e.g., the most important and/or highest-entropy facts). In some cases, the importance determination component 114 selects a predetermined number of facts (e.g., 2, 3, 4, or 5 facts). Alternatively, or in addition, the importance determination component 114 can (a) refrain from selecting facts having an importance score that is below a threshold and/or (b) select all facts having an importance score above a threshold.

The selected facts are generated by the UI component 110 to the user device 102 for presentation by the application 108. In some aspects, the selected facts are displayed from left to right in descending order of importance score (i.e., with the fact having the highest importance score on the left end of a row of facts). This presentation provides an intuitive user experience since, in most languages (including English), words are written and read from left to right. The facts can be displayed as unconnected nodes of a graph.

FIG. 2 illustrates such an example. At block 220, the importance determination component determines that Fact A has an importance score of 0.5, Fact B has an importance score of 0.8, and Fact C has an importance score of 0.7. At block 230, Facts B and C are displayed as unconnected nodes. Fact B is positioned to the left of Fact C since Fact B's importance score is greater than Fact C's importance score. Fact A, which has the lowest importance score, has not been selected by the importance determination component 114 for display (e.g., because an importance threshold was set at 0.6, or because a setting was configured such that the number of displayed facts was capped at 2).

In contrast to at least some conventional methods, calculating importance scores (e.g., entropy scores) for facts allows the facts to be determined and displayed automatically—e.g., without user input (e.g., a user query).

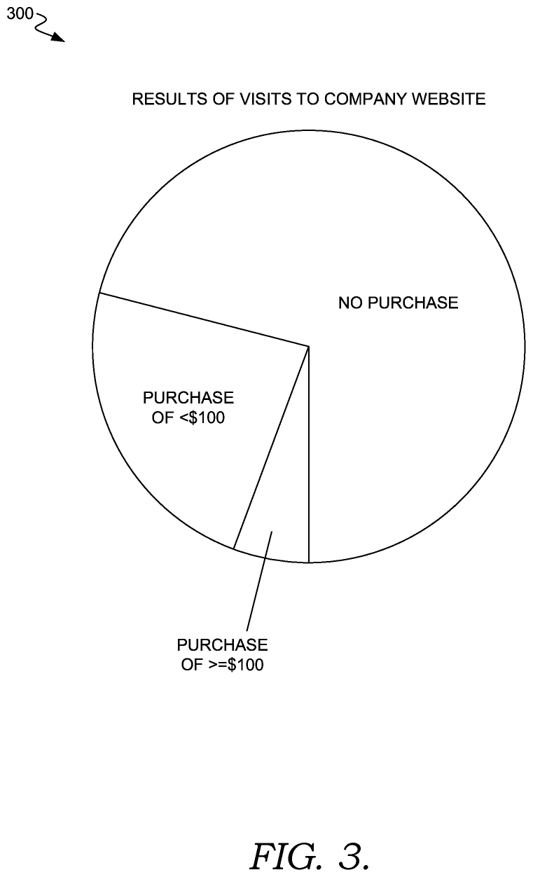

The data insight generator 104 may also allow users to view data visualizations associated with displayed facts—e.g., by selecting (e.g., clicking on) a displayed fact. (In other cases, the data insight generator 104 may display a data visualization by default—e.g., even in the absence of a user selection of an associated fact.) FIG. 3 illustrates such a data visualization 300 for a fact. The visualized fact can be represented by the tuple {type=Pie Chart, subspace=None, measure=Count, breakdown=Purchase Category, aggregate=Sum}, for example. Accordingly, when the fact is selected by a user, the user interface component 110 can generate such a pie chart for display at the user device 102 (e.g., via the application 108), as shown in FIG. 3.

In some cases, a user may wish to further investigate a displayed fact. For example, a user presented with the data visualization 300 of FIG. 3 may wish to assess which factors influence whether a website visitor makes a purchase of at least $100. In such cases, the user can select the displayed fact, and in response, the dependent fact determination component 116 determines and displays one or more dependent facts—i.e., facts that depend from a selected fact. However, in some aspects, the dependent fact determination component 116 pre-generates dependent facts—i.e., generates dependent facts for a parent fact prior to receiving a selection of the parent fact—as discussed in more detail below.

In aspects, the dependent fact determination component 116 determines dependent facts for a selected fact by adding one or more subspaces (e.g., conditions) to the selected fact. That is, the dependent fact determination component 116 can, for example, determine a first dependent fact by adding a first subspace to the parent fact, determine a second dependent fact by adding a second subspace (but not the first subspace) to the parent fact, and so on. The dependent fact determination component 116 can also determine importance scores for each of the dependent facts. In aspects, these importance scores are determined in the same manner as described above with respect to the importance/entropy scores for the initial facts.

In some aspects, the dependent fact determination component 116 also (or alternatively) generates coherence scores for respective dependent facts. Each dependent fact's coherence score indicates how coherent the relationship between the parent fact and dependent fact is. For example, if the parent fact and dependent fact differ only by the inclusion of one subspace, the dependent fact would have high coherence. If the parent fact and dependent fact differ in many ways (e.g., multiple subspaces and/or other parameters), the dependent fact would have comparatively low coherence. In aspects in which coherence scores are determined for dependent facts, the coherence score can be combined with (e.g., added to) the entropy score to produce the importance score for the dependent fact.

The dependent fact determination component 116 can terminate the dependent fact generation process upon (a) generating a predetermined number of dependent facts or (b) generating a predetermined number of dependent facts having importance scores above a threshold, for example. Generating only a predetermined number of dependent facts (instead of, for example, parsing the entire dataset) can reduce the computational costs associated with the dependent fact generation process.

Subsequently, the dependent fact determination component 116 can select dependent facts having the highest importance scores, which the user interface component 110 can generate for display at the user interface of the user device 102 via the application 108. In some aspects, the number of selected dependent facts is predetermined. The user interface can display the selected dependent facts as nodes connected to (e.g., branching from) the parent fact/node from which the dependent nodes depend. The dependent nodes can be displayed from left to right in descending order of importance score.

By presenting a user with (comparatively) high-level initial facts and allowing the user to drill down on one or more initial facts by viewing/selecting dependent facts, aspects of the present invention can decrease computational (and/or other) costs associated with generating data insights. For example, in contrast to some conventional approaches, data insights can be generated automatically (e.g., without depending on a user-provided query), potentially avoiding computational costs associated with receiving, parsing, and/or executing such a query.

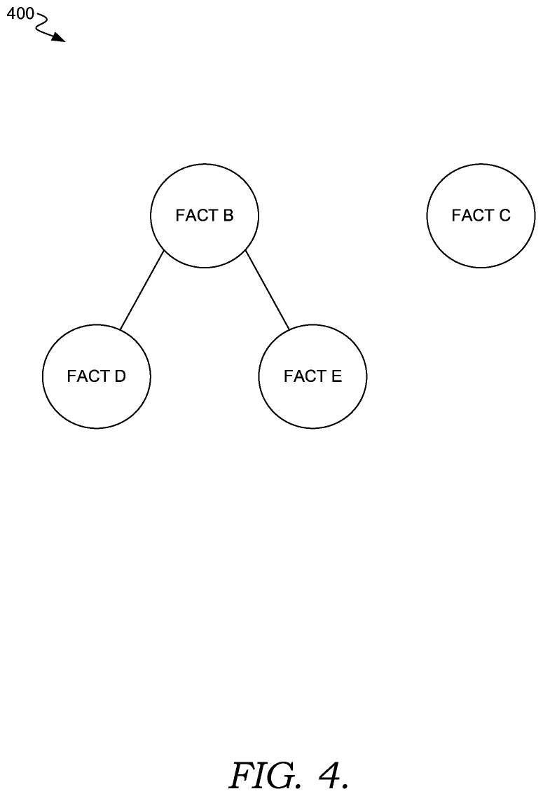

FIG. 4 illustrates an example user interface 400 wherein dependent facts are displayed for a selected fact. In particular, the user interface 400 corresponds to the user interface shown at block 230 of FIG. 2 following a user selection of Fact B. Facts D and E are shown as branching from (i.e., depending from) Fact B. And because it is positioned on the left, Fact D may have a higher importance score than Fact E.

Although FIG. 4 depicts two dependent facts as branching from Fact B, it is contemplated that more—or fewer—dependent facts may be displayed for a parent fact. Additionally, in response to a user selection of an additional fact (e.g., Fact C in the example shown in FIG. 4), the user interface component 110 may generate additional dependent facts for display in addition to (or instead of) an initial set of dependent facts. That is, after displaying facts that depend from Fact B (for example), the dependent fact generation component 116 can receive a user selection of Fact C and generate and/or cause display of facts depending from Fact C. In this manner, a user can drill down on multiple independent fact trees.

The dependent fact generation component 116 can also generate facts that depend from dependent facts—and facts that depend from those facts, and so on. Any of the methods of generating dependent facts described herein can be utilized to generate facts that depend from dependent facts. For example, if a user selects Fact E in FIG. 4, the dependent fact generation component 116 can add one or more additional subspaces (e.g., conditions) to Fact E in order to generate and display facts that depend from Fact E. In this manner, dependent facts can be iteratively generated and displayed—e.g., to facilitate user investigations of facts to a desired level of granularity.

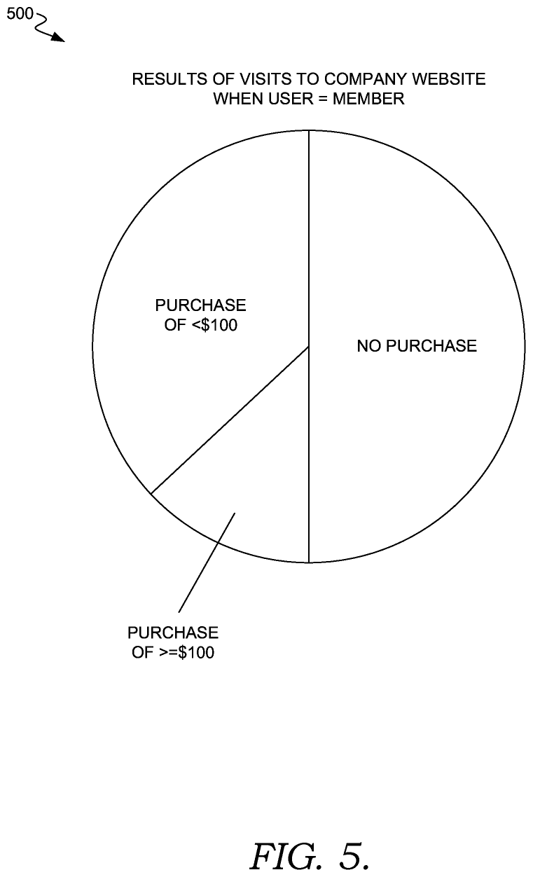

FIG. 5 illustrates an example illustration 500 of a visualization of a dependent fact. The fact visualized in FIG. 5 depends from the fact of FIG. 3 in the sense that it is identical to the fact of FIG. 3 except that the subspace “user=member” has been added. That is, whereas FIG. 3 shows the results of all visits to the company's website, FIG. 5 shows the results of visits to the company website only for members (e.g., of a rewards program). Thus, as shown in FIG. 5, members are more likely than non-members to make purchases of both at least $100 and less than $100 as compared to non-members, and are less likely to make no purchase when visiting the company website.

In some aspects, initial (top-level) facts and dependent facts are both generated prior to building fact trees. Put another way, the fact generation component 112 and/or dependent fact generation component 116 can generate facts having different numbers of subspaces prior to relating facts to each other (e.g., by forming fact trees). In these aspects, facts can be represented as nodes. Pairs of facts can be connected by directed edges extending from the fact with fewer subspaces to the fact with more subspaces. The edges can be assigned weights based on the number of subspaces by which the connected nodes differ. For example, if a first node has one subspace and a second node has two subspaces, a directed edge would extend from the first node to the second node and could have an edge weight of one (i.e., two minus one). Nodes can have multiple outgoing or incoming edges.

Fact trees can be excluded from selection for presentation based on their respective edge weights. For example, fact trees having one or more edge weights greater than one (i.e., having one or more pairs of connected nodes differing by two or more subspaces) can be excluded from selection from presentation. This can ensure that selected fact trees have high coherence.

In some aspects, importance scores are determined for each of the nodes (e.g., by the importance determination component 114). The importance scores can be determined in accordance with any of the aspects previously described herein. For example, nodes' importance scores can be based on entropy scores for the corresponding nodes, as previously described.

In order to, for example, prevent selection and presentation of nodes (i.e., facts) having low information value, the data insight generator 104 can identify and exclude nodes having importance scores that do not fall within predetermined upper and/or lower bounds. This approach weeds out (a) facts having balanced data distributions (high-entropy facts) and (b) facts having imbalanced data distributions (low-entropy facts).

In aspects, the data insight generator 104 determines which of the fact trees to select for display based on the fact trees' corresponding importance scores. For example, the data insight generator 104 can, for each fact tree, sum the importance scores of each node in the fact tree and select one or more fact trees having the highest summed importance scores.

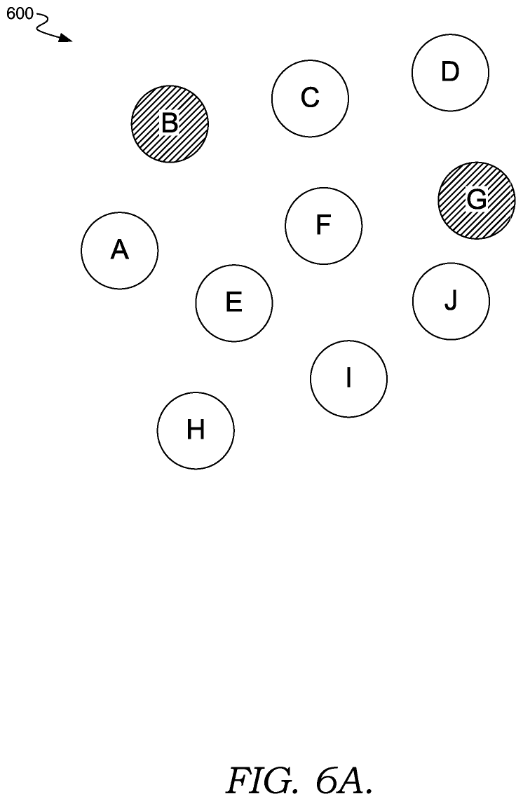

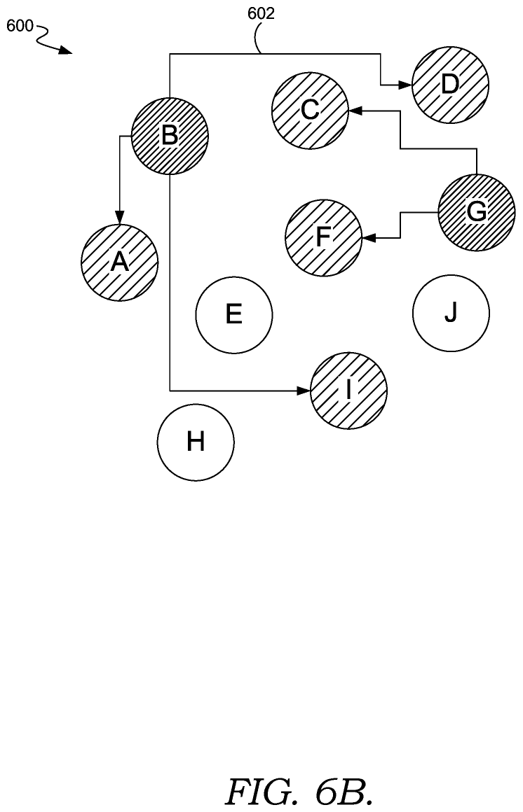

FIGS. 6A-6B illustrate an example process for generating and selecting fact trees. A plurality of facts is generated. A plurality of nodes 600 is created, each node corresponding to a fact of the plurality of facts. The data insight generator 104 identifies nodes/facts having a lowest number of subspaces (e.g., zero subspaces). Such facts are candidates for initial (highest-level) facts to be generated for display by the user interface component 110. In the example shown in FIG. 6A, nodes B and G are the nodes corresponding to facts having the lowest number of subspaces.

As shown in FIG. 6B, directed edges (e.g., 602) are formed between the nodes 600 that represent facts having the lowest number of subspaces (facts B and G) and nodes that represent facts having one or more additional subspaces. In the example shown in FIG. 6B, two fact trees (or node trees) are formed: a first fact tree that includes fact B and its dependent facts (A, D, and I), and a second fact tree that includes fact G and its dependent facts (C and F). The remaining facts (E, H, and J) are not selected for inclusion in either fact tree because, for example, they do not have the same breakdown (e.g., do not correspond to the same column of the dataset 118) as either fact B or fact G.

### Example Methods

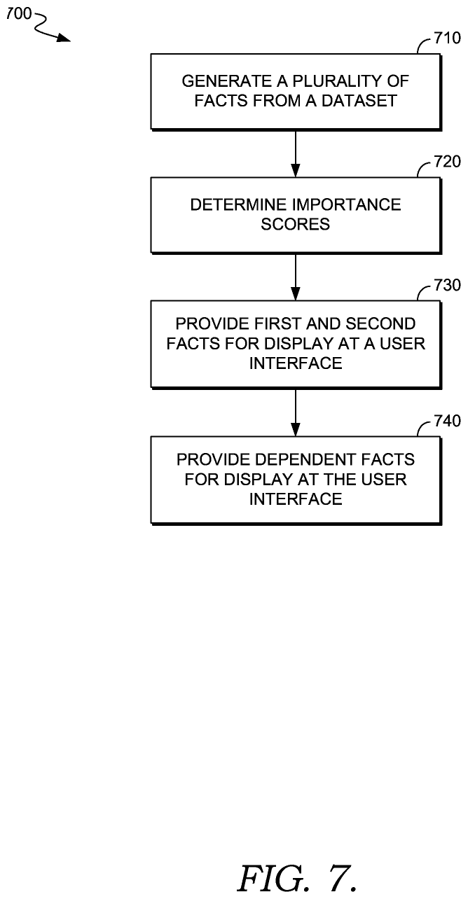

With reference now to FIG. 7, a flow diagram is provided that illustrates a method 700 for providing data insights. The method 700 can be performed, for instance, by the data insight generator 104 of FIG. 1 and related components. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few examples.

At block 710, a plurality of facts is generated from a dataset. The dataset can comprise tabular data—i.e., data organized into rows and columns. Each fact can comprise one or more of a type, a subspace, a measure, a breakdown, and an aggregate. However, in some aspects, the plurality of facts do not comprise a subspace, for example. The facts can be generated by parsing a sample of the dataset. The facts can be generated automatically and/or without parsing a query from a user.

At block 720, importance scores are determined for the plurality of facts. The importance scores can be based on entropy scores for the facts.

At block 730, first and second facts are generated for display at a user interface. The first and second facts can be selected for display based on having the highest importance/entropy scores of the plurality of facts. The first and second facts can be displayed as nodes. Data visualizations of the first and second facts can also be displayed.

At block 740, dependent facts are generated for display at the user interface. The dependent facts can be determined by adding subspaces to the facts displayed at block 730. The dependent facts can be displayed as nodes branching from their respective parent node(s).

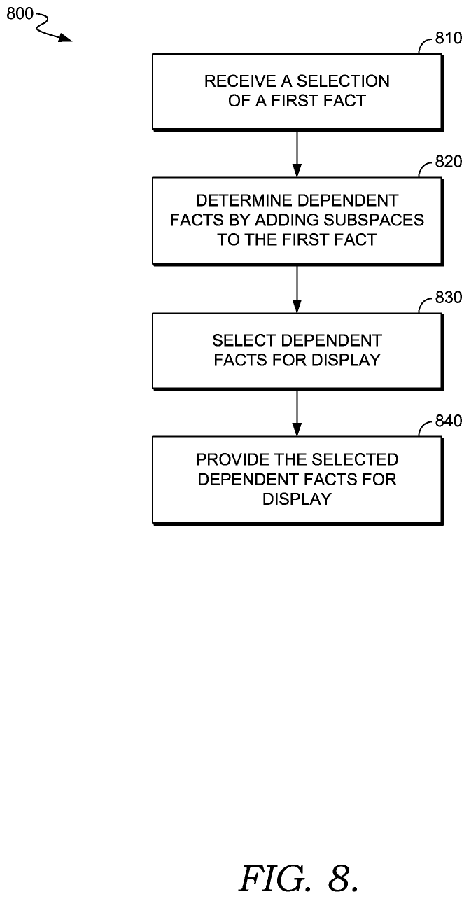

With reference now to FIG. 8, a flow diagram is provided that illustrates a method 800 for providing data insights. The method 800 can be performed, for instance, by the data insight generator 104 of FIG. 1 and related components.

At block 810, a selection of a first fact is received. The selection of the first fact can be received from a user device and/or at a user interface.

At block 820, dependent facts are determined. The dependent facts can be determined by adding one or more subspaces to the first fact. Importance scores can also be determined for the dependent facts. The importance scores can be based on respective entropies of the dependent facts. In some aspects, the importance scores are also based on coherence scores of the dependent facts.

At block 830, dependent facts are selected for display. The selected dependent facts can be the dependent facts with the highest importance scores.

At block 840, the selected dependent facts are generated for display. The dependent facts are displayed at the same user interface as the first fact. The selected dependent facts can be displayed as nodes branching from the first fact. Visualizations (e.g., graphs) of the selected dependent facts can also be displayed.

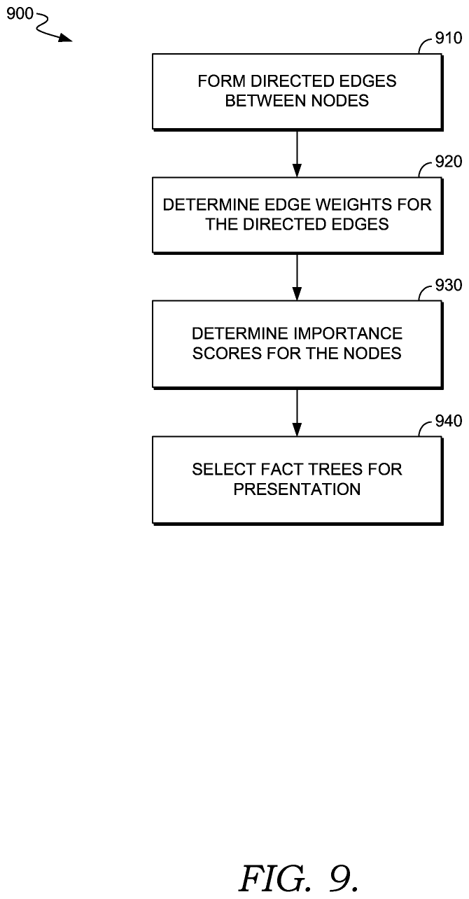

With reference now to FIG. 9, a flow diagram is provided that illustrates a method 900 for providing data insights. The method 900 can be performed, for instance, by the data insight generator 104 of FIG. 1 and related components.

At block 910, directed edges are formed between nodes. Each node represents a fact generated by the fact generation component 112. Each directed edge extends from a fact with fewer subspaces (e.g., conditions) to a fact with more subspaces. In some aspects, directed edges are only formed between facts having a same breakdown (e.g., corresponding to a same column of the dataset 118).

At block 920, edge weights are determined for the directed edges. Each directed edge's corresponding edge weight can be based on a number of subspaces by which the facts connected by the directed edge differ. For example, a directed edge's edge weight can be higher when the difference in number of subspaces is larger. Fact trees having one or more edge weights above a threshold can be excluded from selection for presentation at a user device. In some aspects, every fact tree having at least one pair of connected facts that differs by more than one subspace is excluded from selection for presentation.

At block 930, importance scores are determined for the nodes. The importance scores can be based on entropy scores for the corresponding nodes. An importance score can be determined for each node in a fact tree that has not been excluded from selection for presentation.

At block 940, fact trees are selected for presentation. In some aspects, fact trees are selected for presentation based on having the highest aggregate importance scores (i.e., summed across all nodes in the fact tree). In some aspects, all fact trees (e.g., up to a maximum number of fact trees) having an aggregate importance score above a threshold are selected for presentation. In other aspects, a predetermined number of the highest-scoring fact trees are selected for presentation.

### Exemplary Operating Environment

Having described implementations of the present disclosure, an exemplary operating environment in which embodiments of the present technology can be implemented is described below in order to provide a general context for various aspects of the present disclosure. Referring to FIG. 10, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what can be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory can be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which can be built in. Illustrative components include a microphone, joystick, game pad, satellite dish, scanner, printer, wireless device, etc. The I/O components 1020 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 can be equipped with depth cameras, such as, stereoscopic camera systems, infrared camera systems, RGB camera systems, and combinations of these for gesture detection and recognition. Additionally, the computing device 1000 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

We claim:

1. A system comprising:
a memory component; and
a processing device coupled to the memory component, the processing device to perform operations comprising:
generating a plurality of facts from a dataset by sampling combinations of parameters of the dataset;
determining importance scores for each of the plurality of facts by analyzing uniformities of the facts;
based on the importance scores, generating, for display at a user interface, a first fact of the plurality of facts and a second fact of the plurality of facts by creating data visualizations of the first fact and the second fact,
wherein generating the first fact for display is based on a fact tree of the first fact having a highest aggregate importance score of a plurality of aggregate importance scores generated for a plurality of fact trees; and
based on receiving a selection of the first fact, generating dependent facts for display at the user interface by creating data visualizations of the dependent facts, wherein the dependent facts depend from the first fact.

2. The system of claim 1, wherein each of the dependent facts is determined by adding a condition to the first fact.

3. The system of claim 1, wherein each importance score is based on an entropy of the corresponding fact of the plurality of facts.

4. The system of claim 1, wherein the dataset comprises tabular data, and wherein each of the plurality of facts corresponds to a column of the tabular data.

5. The system of claim 4, wherein the operations further comprise filtering out a column of the dataset based on at least one selected from the following: (a) a number of non-identical values in the column and (b) a number of null values in the column.

6. The system of claim 1, wherein the operations further comprise:
generating a plurality of nodes, each node corresponding to a fact of the plurality of facts;
forming a plurality of directed edges between the plurality of nodes, thereby forming the plurality of fact trees; and
assigning edge weights to each of the plurality of directed edges,
wherein each of the edge weights is based on a number of subspaces by which the nodes connected by the directed edge differ.

7. The system of claim 6, wherein one or more of the plurality of fact trees are generated for display based on a determination that each edge weight in the fact tree corresponds to a difference of exactly one subspace.

8. The system of claim 1, wherein the plurality of facts is generated automatically, and wherein the plurality of facts is not generated based on a query received from a user.

9. A computer-implemented method comprising:
generating, by a fact generation component, a plurality of facts, each of the plurality of facts corresponding to a column of a tabular dataset;
determining, by an importance determination component, entropy scores for each of the plurality of facts;
based on the entropy scores, generating for display, by a user interface component, a first fact and a second fact of the plurality of facts at a user interface; and
based on receiving a selection of the first fact:
determining, by a dependent fact determination component, a plurality of dependent facts, wherein each of the plurality of dependent facts is determined by adding a subspace to the first fact, and
generating for display, by the user interface component, the plurality of dependent facts at the user interface.

10. The computer-implemented method of claim 9, wherein each of the plurality of facts is defined by at least one of a type, a subspace, a measure, a breakdown, and an aggregate.

11. The computer-implemented method of claim 9, wherein the method further comprises filtering out a column of the tabular dataset based on (a) a number of non-identical values in the column and (b) a number of null values in the column.

12. The computer-implemented method of claim 9, wherein the plurality of facts is generated automatically, and wherein the plurality of facts is not generated based on a query received from a user.

13. The computer-implemented method of claim 9, wherein generating the first fact for display at the user interface is based on a fact tree of the first fact having a highest aggregate importance score of a plurality of aggregate importance scores generated for a plurality of fact trees.

14. A system comprising:
a memory component; and
a processing device coupled to the memory component, the processing device to perform operations comprising:
displaying, by a user interface component, a first fact and a second fact of a plurality of facts,
wherein each of the plurality of facts corresponds to a dataset,
wherein the first fact and the second fact are displayed based on importance scores for each of the plurality of facts,
wherein the first fact is displayed further based on a first edge weight for a first directed edge extending from the first fact to a third fact, the first edge weight being based on a first number of subspaces by which the first fact and the third fact differ, and
wherein the second fact is displayed further based on a second edge weight for a second directed edge extending from the second fact to a fourth fact, the second edge weight being based on a second number of subspaces by which the second fact and the fourth fact differ;
receiving, by the user interface component, a selection of the first fact; and
based on the receiving the selection of the first fact, displaying, by the user interface component, the third fact.

15. The system of claim 14, wherein the third fact is determined by adding at least one subspace to the first fact.

16. The system of claim 14, wherein each importance score is based on an entropy of the corresponding fact of the plurality of facts.

17. The system of claim 14, wherein the dataset comprises tabular data, and wherein each of the plurality of facts corresponds to a column of the tabular data.

18. The system of claim 14, wherein the operations further comprise filtering out a column of the dataset based on (a) a number of non-identical values in the column and (b) a number of null values in the column.

19. The system of claim 14, wherein the plurality of facts is generated automatically, and wherein the plurality of facts is not generated based on a query received from a user.

20. The system of claim 14, wherein displaying the first fact at the user interface is based on a fact tree of the first fact having a highest aggregate importance score of a plurality of aggregate importance scores generated for a plurality of fact trees.
